(19) United States
(12) Patent Application Publication
(10) Pub. No.: US 2014/0122432 A1
(43) Pub. Date: May 1, 2014

(54) SYSTEM AND METHOD FOR PROVIDING AUTHENTICATED BACKUP FOR MOVIES, MUSIC AND BOOKS

(71) Applicant: MERRICK SEYMOUR MORGAN, PHOENIX, AZ (US)

(72) Inventor: MERRICK SEYMOUR MORGAN, PHOENIX, AZ (US)

(21) Appl. No.: 13/666,105

(22) Filed: Nov. 1, 2012

(51) Int. Cl. G06F 17/30

(52) U.S. Cl. CPC G06F 17/30091
USPC 707/640

(57) ABSTRACT

A process for securing a backup digital copy of DVDs, music and books a person owns. The process may require the owner cut out the UPC and/or bar code, mail the UPC in and then receive a username and pass-code to download a backup digital copy of their DVD, music and/or book or the owner my receive a backup on portable digital media. Furthermore, proof of ownership may be authenticated not only cutting out the UPC/bar code but also taking a high resolution picture of the actual disk or media with verification markings made by the owner so that the reviewer can see if the ownership is authentic. A picture of the original receipt may also be used to verify ownership. The process may provide ease of getting the back-up copies of the media and it may prevent the customer from paying twice for the same media.

### BACKGROUND

For purchasers, owners and/or collectors of movies, music and books, there may be a desire to secure and maintain backup copies of the works they own. Conventional approaches to creating or acquiring a backup copy may require that the original media containing the work be sent to a third party who will then create a backup and hopefully return the work to the original owner in the same condition in which the work was provided. Other conventional approaches may include stores providing a walk-up self-service option where an owner may bring, for example, a DVD movie, and create a backup copy of the movie.

Neither of these conventional approaches is satisfactory, since not all owners are willing to send their copies out to be backed up. Sending away all of their works at once for backup may leave the owner without the works for a long period of time and sending items out one or a few at a time may not be cost-effective. Further, the owner of a large number of works may require inordinate amounts of time at a self-service counter to accomplish the backing up of an entire collection.

While some services or software may provide for the creation of backup copies are available, very few of these approaches provide much in the way of security for the copyright holders against unlawful copying of protected works.

In many ways, the most effective conventional approach to acquiring and maintaining a backup of one or a collection of works is to purchase second copies of the works.

Improvements to the options for providing backup of movies, music and books are desirable.

### BRIEF DESCRIPTION OF THE DRAWINGS

The accompanying drawing figures, which are incorporated in and constitute a part of the description, illustrate several aspects of the present disclosure and together with the description, serve to explain the principles of the present disclosure. A brief description of the figures is as follows:

FIG. 1 is a logical flow diagram of a backup process according to the present disclosure.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

As stated above, collectors of movies and music and books that want to protect their collection by securing a digital backup of their property have very few legal options for creating such backups. The most time efficient and least cost effective approach to securing such desired backups may be to simply purchase a second copy of each work to be protected. The system and method of the present application provides an approach to address these shortcomings of the conventional approaches. The process according to the present disclosure may allow an owner of a particular work to secure a backup copy digitally of the entertainment media they own without having to pay again to purchase something they own already.

The process of the present disclosure may provide easy and efficient securing a backup copy of the media without the customer risking damage by mailing in DVD's or other media. Instead, copies of receipts, UPC/barcode or pictures of actual media can be emailed, uploaded or mailed.

It is a burden to consumers having to pay twice for the same media. Furthermore to travel with or ship huge volumes of media can be cumbersome and inefficient, and it may expose the media to risk of damage or loss.

The system of the present disclosure may comprise the following elements or steps:

1. A backup service provider may assemble an inventory of a wide variety media types and maintain a database listing the available works and/or titles.

2. A customer may identify from the database if they own the media (DVD, Movies, Books, Music) for a particular work.

3. Once a suitable title has been identified from the database, the customer may then request a digital back-up of the media be provided.

4. The customer then has to submit proof of ownership of the work requested. This proof may be accomplished by cutting out the UPC/Bar Code from the original packaging and mailing it to the service provider, emailing/uploading copies of receipts of ownership/purchase receipts, or taking a picture of the original media with name and/or initials of owner and or company providing the service along with a time stamp and/or date using a pen or permanent marker and emailing or uploading the pictures when the UPCs or original packaging have been lost.

5. Upon receipt of ownership documents, a reviewer at the backup service provider may approve the evidencing supporting proof of ownership and may then send a username and passcode to download the backup copy of the media to the customer or provide an the backup copy to the owner in the form of portable digital media, such as but not limited to sending the backup copy on a portable external hard drive to be mailed with the back-up media.

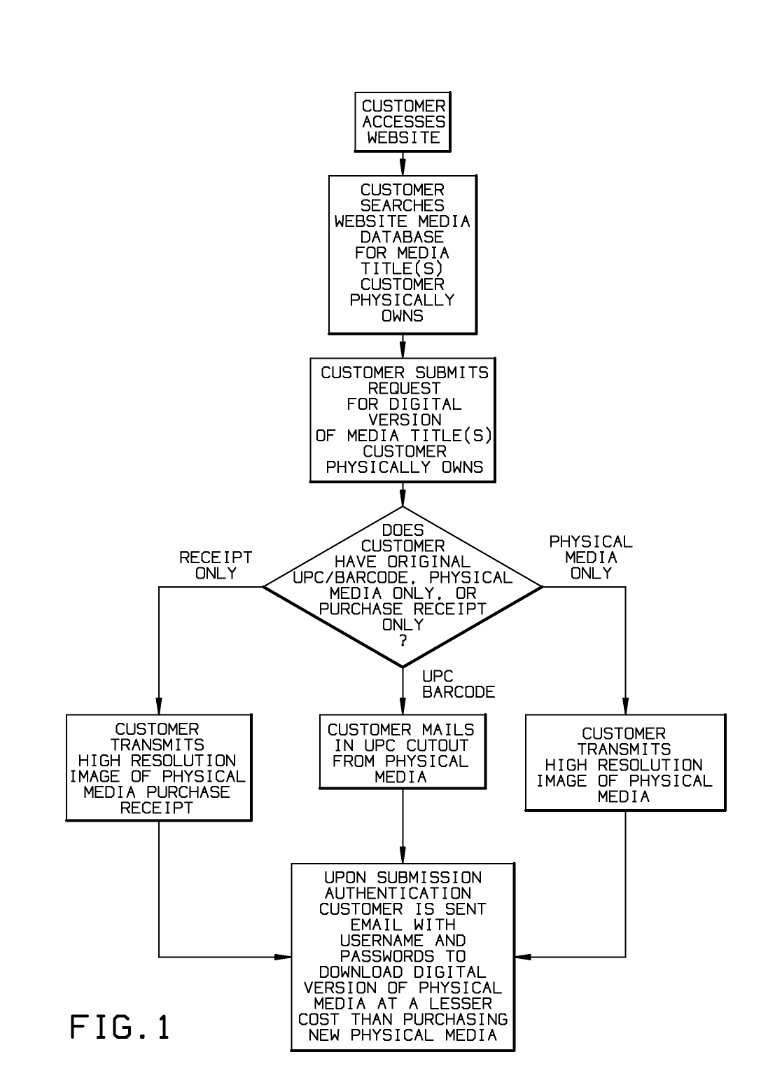

These individual steps, described below and outlined in the accompanying FIG. 1, are preferably fairly rigid and followed in order to secure the back-up digital copy. Such rigorous application of the process will help ensure that only legitimate and proven owners of works may secure the right to a backup copy of their work through the backup service provider.

Box 10 refers to an owner of some particular work or works.

Box 20 refers to the owner determining that one or more selected works from their owned works should be backed up.

Box 30 refers to the owner identifying that the service provider's database includes a listing of the selected work to be backed up.

Box 40 refers to the owner requesting that the service provider deliver a backup copy of the selected work.

Box 50 refers to a first step in the process of determining that the owner is a legitimate verifiable owner of the selected work through verifying an original packaging UPC or barcode.

If the owner has the original UPC code (Box 60), then the owner may forward the UPC for verification by the service provider who may then provide codes or other information needed to download or secure a backup copy to the owner (Box 70).

If the owner does not have access to the original packaging with the original UPC code (Box 80), then the customer may capture a high resolution image of the media that they do possess. This image should be a close enough and detailed enough view to permit the service provider to examine the media for presence of authenticating markings If the image of the media permits verification of the authenticity of the media, then the service provider may then provide codes or other information needed to download or secure a backup copy to the owner (box 90).

If the owner is unable to provide an original UPC code or a clear enough copy of the media itself, the owner may be able to provide a clear image of a receipt of purchase for a digital media clearly identifying the work to be backed up. If the image of the receipt permits verification of the authenticity of the purchase, then the service provider may then provide codes or other information needed to download or secure a backup copy to the owner (box 90).

The process of the system and method of the present application may be broken into three distinct tasks: identifying that the work to be backed up is in the service provider's database; providing proof of ownership; and securing a backup copy of the work. Proof of ownership is necessary to ensure that the backup service is not providing unlicensed copies to persons who are not legitimate owners of original copies of the selected work. Other various ways of providing proof of ownership can be suggested by the owner and reviewed by the service provider to decide if an alternative beyond those options presented herein can be used.

It is envisioned that a service according the present disclosure would permit an owner to be able to secure a digital copy of media they already own at a reasonable price rather than paying full retail price for the media again just to get a backup copy. Furthermore, trying to figure out how to use programs to obtain a digital back-up of the owned media is cumbersome and confusing to customers and expensive.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A method of providing backup copies of works captured on media, the method comprising:
providing a media owner with one or more works captured on media;
providing a service provider with a database of works available for backup;
the owner selecting a work to be backed up;
the owner verifying that the selected work is listed in the database of works available for backup;
the owner requesting a backup of the selected work from the service provider;
the service provider requesting verification of ownership of the selected work;
the owner providing verification of ownership of the selected work;
the service provider sending the owner information regarding how to obtain a backup copy of the selected work once the ownership of the selected work has been verified.

2. The method of claim 1, further providing that the owner verifies ownership of the selected work by sending a UPC from an original packaging of the selected work to the service provider.

3. The method of claim 1, further providing that the owner verifies ownership of the selected work by sending a high resolution image of an original media on which the selected work was acquired to the service provider, wherein the owner may also mark the original media in a distinguishing manner to indicate that the backup copy has been requested for the selected work.

4. The method of claim 1, further providing that the owner verifies ownership of the selected work by sending an image of a purchase receipt indicating the purchase of the selected work by the owner.

5. The method of claim 1, further providing the selected work is one of a movie, music and book.

6. The method of claim 1, further comprising the service provider sending the owner information regarding how to download the backup copy of the selected work.

7. The method of claim 1, further comprising the service provider sending the owner the backup copy of the selected work on portable digital media.

8. The method of claim 7, wherein the portable digital media is a portable hard drive.
